(19) United States
(12) Patent Application Publication
(10) Pub. No.: US 2025/0010452 A1
(43) Pub. Date: Jan. 9, 2025

(54) WORK APPARATUS

(71) Applicant: Andreas Stihl AG & Co. KG, Waiblingen (DE)

(72) Inventors: Ingo Kugler, Waiblingen (DE); Marco Weber, Backnang (DE); David Stäbler, Ostfildern (DE); Philemon Sailer, Murrhardt-Fornsbach (DE)

(21) Appl. No.: 18/762,363

(22) Filed: Jul. 2, 2024

(30) Foreign Application Priority Data
Jul. 3, 2023 (DE) 10 2023 117 454.1
Jul. 3, 2023 (DE) 10 2023 117 456.8
Jul. 3, 2023 (DE) 10 2023 117 457.6

(51) Int. Cl. B25F 5/02; H05B 1/02; H05B 3/36

(52) U.S. Cl. CPC B25F 5/02; H05B 1/0227; H05B 3/36

(57) ABSTRACT

A work apparatus includes a tool, a drive motor for driving the tool, at least one handle for guiding the work apparatus during operation, at least one electric heater for the handle, an electric energy store which supplies the drive motor and the at least one heater with electric energy, and a control unit which is configured to control the electric power supplied to the at least one heater. It is provided that the work apparatus is configured to provide the maximum electric power made available to the at least one heater as a function of a charging state of the energy store. The control unit only switches the at least one heater on and off, and the heater in the switched-on state is operated directly with the voltage provided by the energy store.

### CROSS-REFERENCE TO RELATED APPLICATIONS

This application claims priority of German patent application nos. 10 2023 117 454.1, 10 2023 117 456.8 and 10 2023 117 457.6, filed Jul. 3, 2023, the entire contents of which are incorporated herein by reference.

### SUMMARY

It is an object of the disclosure to provide a work apparatus having an advantageous construction.

This object is, for example, achieved by a work apparatus having: a tool; a drive motor for driving the tool; a handle for guiding the work apparatus during operation; an electric heater for the handle; an electric energy store configured to supply the drive motor and the electric heater with electric power; a control unit configured to control the electric power supplied to the electric heater; and, wherein the work apparatus is configured to provide a maximum electric power made available to the electric heater as a function of a charging state of the electric energy store, whereby the control unit only switches the electric heater on and off, and whereby the electric heater in a switched-on state is operated directly with a voltage provided by the electric energy store.

It is provided according to the disclosure that the work apparatus is configured to provide the maximum electric power made available to the at least one heater as a function of the charging state of the energy store. As a result, the maximum heating power made available to the heater can be adapted to the charging state of the energy store. In particular, the operating time of the tool can be extended by reducing the maximum power made available to the heater. This is particularly advantageous when the maximum electric power made available to the heater is reduced if only a small amount of electric energy is still stored in the energy store.

In particular, the control unit of the work apparatus is configured to provide the maximum electric power made available to the at least one heater as a function of a charging state of the energy store.

In particular, the control unit feedback-controls the electric power supplied to the at least one heater. Feedback-controlling the electric power is presently understood to mean a special case of controlling the electric power.

The control unit controls particularly the mean electric power supplied to the at least one heater. The supplied mean electric power is in particular feedback-controlled, for example as a function of the measured value of the at least one temperature sensor.

A simple construction is derived when the control unit only switches the at least one heater on and off.

In particular, the heater in the switched-on state is operated directly with the voltage provided by the energy store.

Rapid heating is possible owing to the fact that the heater in the switched-on state is operated directly with the voltage provided by the energy store. The voltage provided by the energy store drops as the amount of energy in the energy store drops. Owing to the fact that the at least one heater is operated directly with the voltage of the energy store, it is possible to adapt the maximum power made available for the at least one heater in a simple manner.

Alternatively or additionally, the maximum electric power made available to the heater can be reduced to a diminished value when a predefined value for the residual charge of the energy store is undershot.

The work apparatus, particularly the control unit, is in particular configured to feedback-control the electric power supplied to the at least one heater, in particular as a function of the temperature measured by a temperature sensor of the heater. The electric power herein can be a mean electric power or the maximum electric power made available. In the process, the duration during which the heater is supplied with electric power within a temporal interval can be feedback-controlled, for example. Feedback-controlling can be performed by way of pulse width modulation, for example. The electric power actually made available to the at least one heater can be less than the maximum electric power made available to the at least one heater that is provided as a function of the charging state of the energy store.

It can be provided that the work apparatus has a heater for each of its handles. Alternatively, it can be provided that the work apparatus, in addition to at least one handle with a heater, has one or a plurality of handles without a heater.

The electric energy store can be, for example, a battery or a rechargeable battery. The electric energy store can be disposed partially or completely within a housing of the work apparatus, for example as a rechargeable battery that is able to be inserted and/or retrieved without tools. Alternatively, the electric energy store can be held on the housing. By way of example, it can alternatively also be provided that the energy store is a rechargeable battery disposed outside a housing of the work apparatus. By way of example, the electric energy store can be a rechargeable battery pack, in particular backpack, which is connected to the work apparatus by way of a cable.

In particular, the at least one heater has a temperature sensor. In particular, each heater has a temperature sensor. In one variant of embodiment, the work apparatus can have at least one heater with temperature sensor, and at least one heater without temperature sensor. The work apparatus, in particular the control unit, is configured to in particular feedback-control the electric energy made available to the at least one heater as a function of a measured value of the temperature sensor. In one variant of embodiment, the measured value of the temperature sensor of a heater herein can be utilized for feedback-controlling other heaters which in particular do not have any temperature sensor.

The measured value of the temperature sensor can be a temperature value, for example. Alternatively, the temperature sensor can deliver a measured value that only indicates that a predefined temperature value has been exceeded or undershot. The term “temperature sensor” presently includes all means which can be used for detecting a temperature value.

The control unit is in particular configured to interrupt the supply of electric power to the at least one heater if one or a plurality of events occur. An event can be, for example, reaching or exceeding a memorized maximum temperature. An event can be, for example, identifying a malfunction, in particular due to implausible measured values. This can be, for example, identifying a broken cable, for example due to implausibly low measured values of the temperature sensor.

A two-position controller is in particular provided for operating the at least one heater. The at least one heater is supplied with heating power until the temperature ascertained by the at least one temperature sensor exceeds a first temperature limit value. The supply of heating power is subsequently interrupted until a second temperature limit value is undershot. The second temperature limit value herein lies below the first temperature limit value. When the second temperature limit value is undershot, the at least one heater is supplied with heating power again until the temperature increases beyond the first temperature limit value again. In this way, the temperature can be maintained between the first and the second temperature limit value in a simple manner.

The heating power with which the at least one heater is supplied can be the maximum power or a diminished mean electric power. The diminished mean electric power is provided by switching on and off, in particular rapidly switching on and off, the power supply to the at least one heater.

The at least one heater includes in particular a heating foil. The heating foil includes in particular a carrier material of plastics material, and a conductor path which is printed on the carrier material or embedded in the carrier material.

The temperature sensor is in particular disposed at or on the heating foil. As a result, the temperature of the heating foil, and thus the temperature of the handle, can easily be determined in a comparatively precise manner. The temperature sensor is in particular not disposed directly on a base body of the handle.

The temperature sensor is in particular disposed on the handle. If the temperature sensor is disposed at or on the heating foil, it is provided in particular that the heating foil is disposed conjointly with the temperature sensor on the handle.

A handle on which a heating foil having a temperature sensor is disposed is in particular a tubular handle of the work apparatus. In particular, the handle, particularly the tubular handle, has a curved section and the temperature sensor is disposed on the curved section of the handle.

In particular, the work apparatus has an activator/means for switching on the at least one heater by the operator. As a result, the operator can decide whether heating the at least one handle is desired. In the case of a plurality of handles with heaters, a switch or any other means for switching on all heaters can be provided. Alternatively, the heaters can be able to be switched on separately from one another, in particular by way of a common switch or by way of separate switches.

The work apparatus is in particular configured in such a manner that the means for switching on the at least one heater enable the at least one heater to be switched on independently of the operation of the tool. In particular, the heater can already be switched on when the work apparatus has not yet been put into operation. In the case of work apparatuses of this type, it is usually necessary to activate at least two operator controlled elements for putting the tool into operation, so as to prevent any unintentional operation. Switching on the heater is in particular possible independently of putting the tool into operation. As a result, the operator can easily switch on the heater of the at least one handle without the tool of the work apparatus being put in operational readiness. It can be provided that the work apparatus has an activation switch which serves to activate the control unit and has to be activated before the at least one heater can be switched on.

A high level of comfort for the operator can be achieved in particular when the work apparatus is specified in such a way that the operator can set at least two different target temperatures for the at least one heater. As a result, the at least one handle can be heated to a greater or lesser extent depending on the ambient temperature, the heat perceived by the operator and/or the chosen clothing of the operator. It is provided in particular that the operator can set the target temperature of at least one heater in a stepless manner, for example by way of a potentiometer or by way of an external device, in particular by way of a smartphone, tablet or the like.

The work apparatus has in particular at least one switch for the at least one heater. As a result, the heater can be easily switched on and/or off by the operator, and/or a target temperature for the heater can be set.

The switch is in particular disposed on a top side of the work apparatus. As a result, the switch is easily accessible for the operator. The switch position of the switch can be easily identified by the operator. In particular, a switch by way of which the heater can be switched on and the at least two target temperatures can be set is provided. A rocker switch having at least three switch positions is in particular provided.

A handle of the work apparatus is in particular configured as a tubular handle. In particular, the tubular handle engages across the top side of the work apparatus by way of a spacing. In a view from above onto the work apparatus, the switch has in particular a spacing of less than 5 cm from the section of the tubular handle that engages across the top side of the work apparatus. Owing to the fact that the switch is disposed comparatively close to the section of the tubular handle that engages across the top side of the work apparatus, the operator can ergonomically activate the switch using one hand which holds the section of the tubular handle during operation.

In order to enable comfortable setting of the target temperature it is provided in particular that the target temperature is able to be set by way of an external device such as, for example, a smartphone, a tablet or the like. For this purpose, the work apparatus has in particular a connecting unit for establishing a data connection to the external device. The data connection is in particular a wireless data connection such as, for example, a Bluetooth connection. The work apparatus is in particular configured in such a manner that at least one of the at least two target temperatures is able to be set by way of the external device. Stepless setting of the target temperature can also be provided.

A corresponding program is in particular to be installed on the external device for setting at least one target temperature. Alternatively or additionally, it can be provided that the at least one heater is able to be switched on and off by way of the external device. Setting different target temperatures for different heaters of the work apparatus can also be provided, in particular by way of the external device.

An increased power input of the tool can occur in work apparatuses during operation. This may be the case, for example, if particularly hard or large workpieces are to be machined, or the tool is blocked in the workpiece. In order to be able to make available a high power for machining the workpiece in these cases, it is provided in particular that the work apparatus, in particular the control unit, is configured to set the electric power made available to the at least one heater as a function of the electric power taken up by the tool. For example, it can be provided that the maximum electric power made available to the heater is lowered to a predetermined value, or that the electric power made available to the heater is lowered, for example in terms of percentages thereof, if the electric power taken up by the tool exceeds a predefined threshold value. It can also be provided that the power made available to the heater is lowered to zero, the heater thus being switched off. Lowering the power made available to the heater or the maximum power made available to the heater, or switching off, is preferably only temporary. The power made available to the heater is in particular reset to the initial value if the electric power taken up by the tool drops again, for example below the predetermined value.

In particular, the control unit for the at least one heater is a first control unit, and the work apparatus includes a second control unit which is configured to actuate the drive motor. The first control unit and the second control unit are in particular configured separately from one another. In particular, the first control unit and the second control unit are control modules that are configured separately from one another. The first control unit and the second control unit are in particular configured separately from one another in such a manner that the first control unit and the second control unit can be uninstalled separately from one another from a housing of the work apparatus. The first control unit and the second control unit can have mutually separate circuit boards, for example. In particular, the first control unit and the second control unit are disposed so as to be spatially separated from one another in the work apparatus. Owing to the fact that the first control unit and the second control unit are configured separately from one another, in particular as control modules configured separately from one another, it is possible to provide work apparatuses with a heater and with a first control unit, and work apparatuses without a heater and without a first control unit, for a model range of work apparatuses. The production of work apparatuses of different configurations is easily possible as a result.

In the case of the first control unit and the second control unit being separately configured, it is provided in particular that the first control unit and the second control unit are cooled separately from one another.

In an alternative advantageous configuration embodiment it can be provided that the control unit for the at least one heater is integrated in the control unit for actuating the drive motor.

It can be provided that the control unit is configured to separately control the electric power supplied to all heaters, or to conjointly control the electric power supplied to all heaters. Alternatively, it can be provided that the work apparatus has one or a plurality of heaters in which the supplied electric power is not controlled by the control unit.

The work apparatus has in particular at least two handles which have in each case one heater. In particular, each heater has a temperature sensor. In particular, the first handle has a first temperature sensor, and the second handle has a second temperature sensor.

A handle that has a heater is in particular configured as a tubular handle. A handle that has a heater has in particular at least one operator controlled element which serves in particular to actuate the drive motor. A handle that has a heater is in particular a rear handle. Alternatively, a handle that has a heater can be an upper handle.

In particular, the control unit controls the electric power supplied to the at least two heaters independently of one another.

An independent inventive step relates to the configuration embodiment of the handle assembly. In a work apparatus having a handle assembly, whereby the work apparatus has a tool and a drive motor for driving the tool, whereby the handle assembly includes a handle and a heater for the handle, whereby the handle has at least one operator controlled element for actuating a drive motor of the work apparatus, whereby the heater has a heating element which is disposed in an interior space of the handle and a carrier which is disposed in the interior space of the handle and on which the heating element is held and which positions the heating element on an inner surface of the handle, an elastic layer is disposed between the carrier and the heating element.

It is provided that an elastic layer is disposed between the carrier and the heating element. Tolerances between the carrier and the inner surface of the handle can be compensated for by the elastic layer, and the heating element can in particular be positioned over the full area on the inner surface of the handle. The elastic layer enables in particular that the heating element is positively pressed against the inner surface of the handle by the carrier. A good thermal transfer from the heating element to the handle can easily be achieved as a result. In particular, heat-conducting elements between the heating element and the inner surface of the handle can be dispensed with, so that this results in a simplified construction.

The elastic layer advantageously has temperature-insulating properties. As a result, the thermal transfer from the heating element to the carrier is reduced in such a way that more heat is available to the handle. The elastic layer causes in particular a reduction in the thermal transfer from the heating element to the carrier, as well as an improved thermal transfer from the heating element to the handle owing to the heating element resting on the handle in an improved manner. As a result, the amount of energy required for heating the handle can be reduced, and the handle can be more rapidly heated.

The thermal conductivity λ of the elastic layer is in particular less than 1 W/(mK), in particular less than 0.5 W/(mK).

In order to be able to positively compensate for tolerances, it is provided in particular that a thickness of the elastic layer is greater than a thickness of the heating element. The thickness of the elastic layer is in particular the minimum thickness of the elastic layer in a region that is covered by the heating element. The thickness is measured in particular in a region of the elastic layer that lies between the carrier and the heating foil. The thickness is in particular constant in the region that is covered by the heating foil. The thickness of the elastic layer can in particular be at least 0.3 mm, in particular at least 0.5 mm. The thickness of the elastic layer can in particular be at most 2 mm, in particular at most 1.5 mm, in particular at most 1.0 mm.

The thickness of the elastic layer is in particular greater than a thickness of the carrier. The carrier is in particular configured to be planar and thin. The thickness of the carrier is measured in particular in a region that is covered by the elastic layer, in particular by the elastic layer and the heating element. The thickness of the carrier is in particular a maximum thickness of the carrier in this region. The thickness of the carrier is in particular constant in the region that is covered by the elastic layer. Alternatively, it can be provided that the carrier has different thicknesses in the region covered by the elastic layer and the heating element, and the thickness of the carrier is less than the thickness of the elastic layer at least in one region. In particular, the thickness of the carrier over at least 50% of the area of the region covered by the elastic layer and the heating element is less than the thickness of the elastic layer in the respective region.

The thickness of the carrier is at least 0.1 mm, in particular at least 0.2 mm, in particular in one region, in particular over at least 50%, in particular over at least 80% of the area of the region covered by the elastic layer. The thickness of the carrier is at most 1 mm, in particular at most 0.8 mm, in particular in one region, in particular over at least 50%, in particular over at least 80%, of the area covered by the elastic layer. If the carrier is at least partially composed of plastics material, a greater thickness of the carrier may also be advantageous.

The heating element is in particular a heating foil. The heating foil is in particular a film of plastics material which has a conductor path as a heating wire.

The elastic layer is in particular composed of plastics material. The elastic layer is in particular a layer composed of expanded plastics material. For example, the elastic layer can be embodied as an adhesive tape and fix the heating element to the carrier. The elastic layer is composed in particular at least partially, in particular largely, in particular completely, of polyethylene (PE).

Another configuration embodiment of the elastic layer can also be advantageous.

It is provided in particular that the carrier presses the heating element against the inner surface of the handle. Accordingly, the carrier pre-loads the heating element in relation to the inner surface of the handle. By virtue of the elastic layer and the contact pressure, it can be achieved in a simple manner that the heating element rests in a planar manner on the inner surface of the handle.

The carrier is in particular at least partially, in particular at least in the region covered by the elastic layer, in particular completely, composed of metal. In particular in the region covered by the elastic layer, the carrier can in particular completely be composed of aluminum. The carrier is in particular a bent metal sheet.

In particular, a temperature sensor is disposed on the heating element. The temperature sensor is in particular disposed on the side of the heating element that faces the elastic layer. Owing to the fact that the temperature sensor is disposed on the heating element, the temperature of the heating element, and thus the temperature of the handle, can be detected in a comparatively precise manner. By disposing the temperature sensor on the side of the heating element that faces the elastic layer, the installation height of the temperature sensor can be compensated for by the elastic layer. The temperature sensor can be impressed into the elastic layer. As a result, a flat outer surface of the heating element can be achieved in a simple manner, so that it can be achieved that the heating element positively rests on the inner surface of the handle also in the region of the temperature sensor.

At least one connecting line is in particular connected to a connecting point of the heating element. The connecting lines serve in particular to supply the heating element with electric energy. The connecting point has in particular a spacing of at least 1 cm, in particular of at least 2 cm, from the temperature sensor. The spacing herein is measured along the heating element. If the heating element has cutouts, slits or the like, the spacing between the temperature sensor and the connecting point is measured about the cutout or the slit on the heating element. Accordingly, the spacing describes the path to be covered on the heating element from the connecting point to the temperature sensor.

In particular, the elastic layer covers the heating element over at least 80%, in particular over at least 90%, of the area of the heating element. In particular, the elastic layer completely covers the heating element with the exception of the connecting point. A soldered connection which enlarges the thickness of the heating element is usually provided at the connecting point. It can be advantageous to provide a cutout in the elastic layer in this region.

In particular, the carrier covers the elastic layer over at least 80% of the area of the elastic layer. As a result, pre-loading the elastic layer in relation to the heating element, and pre-loading the heating element in relation to the inner surface of the handle, is possible over the majority of the area of the heating element. In particular, the carrier covers the elastic layer over more than 90% of the area of the elastic layer. The carrier can completely cover the elastic layer, in particular with the exception of cutouts in the carrier, for example for fastening elements or the like. The carrier advantageously completely covers the elastic layer on the peripheral edge of the latter.

For a work apparatus having a handle assembly it is provided that the work apparatus has a tool and a drive motor for driving the tool. The work apparatus is in particular a hand-guided work apparatus. In particular, the work apparatus is a work apparatus which is to be hand-held, and in particular to be carried, by an operator during operation. The work apparatus can be, for example, a chainsaw, an angle grinder, or the like. It can also be provided that the work apparatus is a lawnmower or a similar apparatus guided on the ground.

The carrier is in particular disposed on a handle which has at least one operator controlled element for actuating a drive motor of the work apparatus. Handles of work apparatuses that have at least one operator controlled element for actuating a drive motor of the work apparatus are often configured as formed components, for example as plastic injection-molded parts. Handles of this type often have an uneven configuration embodiment and an uneven inner surface. The elastic layer according to the invention is particularly advantageous for handles with an uneven inner surface.

An independent inventive step relates to a work apparatus having an advantageous construction. For a work apparatus which includes a tool, a drive motor for driving the tool, and at least one handle for guiding the work apparatus during operation, whereby the handle is configured as a tubular handle, whereby the handle includes a base body which is configured as a metal tube, whereby the handle by way of a first end region of the base body and by way of a second end region of the base body is fixed to a housing of the work apparatus, it is provided that at least one end region of the base body is fixed to the housing by way of a fastening adapter, whereby the fastening adapter has a receiver into which the end region of the base body protrudes, and whereby the fastening adapter has at least one fastening opening for releasably fixing the fastening adapter to the housing.

Owing to the fact that the end region of the handle is disposed in the receiver of the fastening adapter, no forming of the end region of the handle is necessary. Instead, the fastening adapter can be configured in such a way that it can receive the circular external circumference of the end section of the handle, and in terms of its shape is adapted to the outer contour of the work apparatus. By using a suitable fastening adapter it is in particular possible to selectively fix a handle with a base body made from an aluminum tube, or a handle produced completely from plastics material, to a housing of a work apparatus. The fastening points of the fastening adapter advantageously correspond to the fastening points that are provided for a handle produced from plastics material. As a result, the housing of the work apparatus can be used in many different ways.

Both end regions of the base body of the handle are advantageously fixed to the housing by way of fastening adapters.

A fastening adapter for a first end region of the base body is in particular fixed to a longitudinal side of the housing. A fastening adapter for a second end region of the base body is in particular fixed to a bottom side of the housing.

The work apparatus advantageously has a rest position in which the work apparatus stands on a flat, horizontal rest surface. The longitudinal side of the housing is advantageously a side of the housing which in the rest position of the work apparatus is visible in a horizontal viewing direction onto the work apparatus. The bottom side of the housing is advantageously the side of the housing that in the rest position faces the rest surface.

In particular, at least one fastening adapter is held in a form-fitting manner in at least one plane in a cutout of the housing. The plane in which the fastening adapter is held in a form-fitting manner is preferably a plane which is horizontally disposed in the rest position of the work apparatus. The fixing in a direction that is vertical in the rest position is advantageously performed by way of at least one fastening screw by way of which the fastening adapter is fixed to the housing. The cutout in which the fastening adapter is held in a form-fitting manner in the at least one plane enables simple and precise positioning of the fastening adapter on the housing and positive fixing of the fastening adapter.

In order to achieve positive fixing of the end region of the handle in the fastening adapter it is advantageously provided that at least one end region has an opening into which a position securing element protrudes. The position securing element establishes in particular the position of the end region in relation to the fastening adapter in the longitudinal direction of the metal tube of the handle. As a result it is reliably prevented in a simple manner that the end region can slip out of the receiver of the fastening adapter.

The metal tube of the handle is in particular an aluminum tube.

A simple configuration embodiment is derived when the end region is held in a clamped manner in the fastening adapter. In particular, the fastening adapter has a clamping slit on the receiver. The clamping of the end region in the receiver is advantageously performed by way of a clamping screw which compresses the clamping slit.

Alternatively, it can be provided that the fastening adapter has at least two parts which delimit the receiver and between which the end region is held in a clamped manner.

In particular, at least one end region has a circular outer contour. Owing to this fact it is not necessary to form the circular metal tube in the end region. The production is simplified. Nevertheless, a sufficient length for fixing the handle to the housing can be provided by a suitable configuration embodiment of the fastening adapter.

The handle has in particular a heater. The heater advantageously includes a heating foil which is disposed on the metal tube and by way of at least one connecting line is connected to an energy supply.

In particular, at least one receiver has a cutout for a connecting line of the heater for the handle. Owing to the fact that the cutout is integrated in the receiver, the connecting line for the heater can be installed easily and safe from damage.

In particular, at least one fastening adapter is at least partially, in particular completely, composed of plastics material. Alternatively or additionally, it can be provided that at least one fastening adapter is at least partially, in particular completely, composed of metal. In particular, it can be provided that at least one fastening adapter is completely or partially composed of light metal, in particular of aluminum and/or magnesium, or a magnesium and/or aluminum alloy.

### BRIEF DESCRIPTION OF DRAWINGS

The invention will now be described with reference to the drawings wherein:

FIG. 1 shows a schematic illustration of a work apparatus in a lateral view;

FIG. 2 shows a fragmented view from above onto the work apparatus from FIG. 1 in the direction of the arrow II in FIG. 1, and an external device, in a schematic illustration;

FIG. 3 shows a schematic illustration of the control and of the energy supply of components of the work apparatus;

FIG. 4 shows a schematic diagram which by way of example shows the maximum electric power made available to the at least one heater as a function of a temperature;

FIG. 5 shows a schematic diagram which by way of example shows the maximum electric power made available to the at least one heater as a function of the charging state of the energy store;

FIG. 6 shows a schematic diagram which by way of example shows the mean power made available to the at least one heater, and the maximum electric power made available;

FIG. 7 shows a schematic circuit diagram which shows the separate feedback-control of the electric power made available for two heaters;

FIGS. 8 to 10 show schematic circuit diagrams which show potential embodiments of a common feedback-control of the electric power made available for two heaters;

FIG. 11 shows a fragmented perspective exploded illustration of the second handle having the heater disposed thereon;

FIG. 12 shows a fragmented perspective illustration of the work apparatus in the region of a first fastening adapter of the second handle;

FIG. 13 shows an exploded illustration of the first end region of the second handle and of the first fastening adapter;

FIG. 14 shows a lateral view of the work apparatus in the region of the first fastening adapter;

FIG. 15 shows a view from above onto the first fastening adapter;

FIG. 16 shows a perspective view of the first fastening adapter;

FIG. 17 shows a lateral view of the first fastening adapter in the direction of the arrow XVII in FIG. 15;

FIG. 18 shows a fragmented lateral view of the work apparatus in the region of the second fastening adapter of the second handle;

FIG. 19 shows a perspective illustration of the work apparatus in the region of the second fastening adapter;

FIG. 20 shows an exploded illustration of the second end region of the second handle and of the second fastening adapter;

FIG. 21 shows a perspective view onto the bottom side of the housing of the work apparatus and of the first end region of the second handle;

FIG. 22 shows a perspective illustration of a lower part of the second fastening adapter;

FIG. 23 shows a view from above onto the lower part of the second fastening adapter;

FIG. 24 shows a lateral view of an upper part of the second fastening adapter;

FIG. 25 shows a view of the upper part of the second fastening adapter in the direction of the arrow XXV in FIG. 24;

FIG. 26 shows a perspective sectional illustration of the first handle;

FIGS. 27 and 28 show lateral views of the first handle with the cover part removed;

FIG. 29 shows a sectional illustration of the first handle;

FIG. 30 shows an enlarged sectional illustration through the first handle in the region of the heating element;

FIG. 31 shows an exploded illustration of the second heater; and,

FIG. 32 shows a lateral view of the heating foil and of the connecting lines of the second heater disposed thereon.

### DETAILED DESCRIPTION

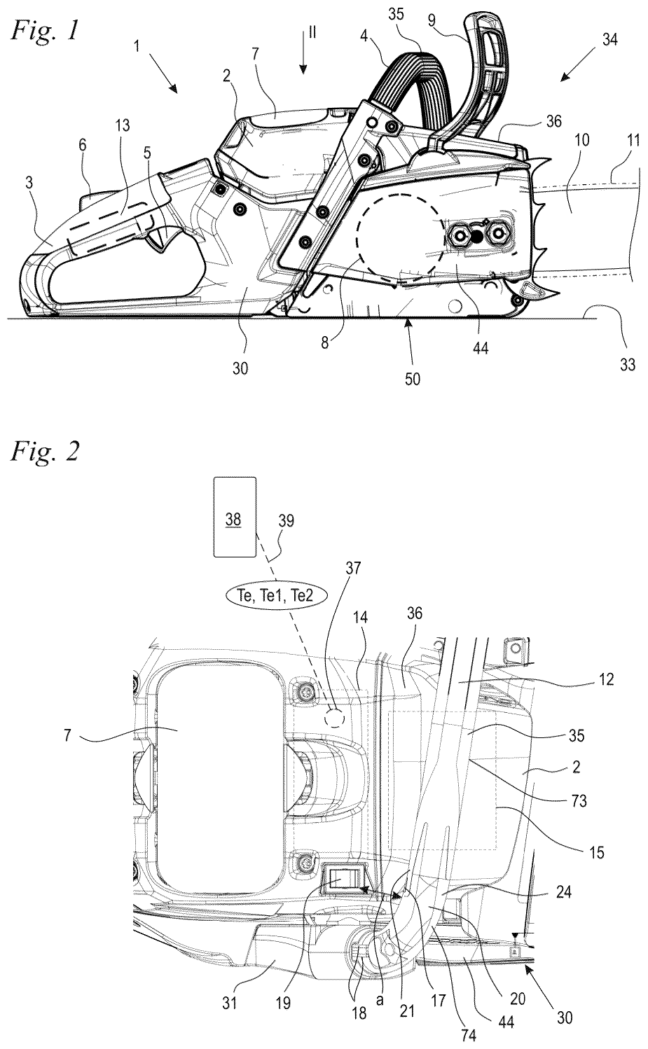

FIG. 1 shows a chainsaw as an embodiment of a work apparatus 1. However, the work apparatus 1 may also be any other work apparatus. The work apparatus 1 is in particular a hand-guided work apparatus which is hand-held during operation, such as a chainsaw, an angle grinder, a brush cutter, or the like. The work apparatus 1 can also be a work apparatus which is guided on the ground during operation, such as a lawnmower, for example.

The work apparatus 1 includes a housing 2. A first handle 3 and a second handle 4 are fixedly established on the housing 2. The first handle 3 in the embodiment is a rear handle. However, the first handle 3 can also be an upper handle. The second handle 4 is a tubular handle in the embodiment. Operator controlled elements 5 and 6 are disposed on the first handle 3. The work apparatus 1 has a drive motor 8 which serves to drive a tool of the work apparatus 1. The drive motor 8 is an electric motor. The drive motor 8 is disposed in the housing 2. The operator controlled element 5 serves to actuate the drive motor 8. The operator controlled element 6 is in particular a blocking lever. Actuating the drive motor 8 by way of the operator controlled element 5 is in particular possible only when the operator controlled element 6 is activated.

For supplying the drive motor 8 with energy, the work apparatus 1 has an electric energy store 7. The energy store 7 in the embodiment is held so as to be interchangeable in the housing 2. The energy store 7 is in particular a rechargeable battery. Alternatively, the energy store 7 can be a battery, for example.

The work apparatus 1 has a saw chain 11 as a tool, which is guided so as to revolve on a guide bar 10. The saw chain 11 is only schematically illustrated in FIG. 1 and is of a construction that is customary for saw chains. The saw chain 11 is driven by the drive motor 8 so as to revolve about the guide bar 10 during operation.

A hand guard 9 is disposed on the side of the second handle 4 that faces the saw chain 11 and the guide bar 10. The hand guard 9 is in particular mounted so as to be movable on the housing 2 and can serve to trigger a brake unit, not illustrated, for the saw chain 11.

FIG. 1 shows the work apparatus 1 in a rest position 34 in which the work apparatus 1 stands on a flat, horizontal rest surface 33. The housing 2 has a top side 36 which in the rest position 34 is the side of the housing 2 that points upward. The top side 36 is the visible side of the housing 2 when viewed perpendicularly downward onto the work apparatus 1 located in the rest position 34. The housing 2 has a bottom side 50. The bottom side 50 is the side of the housing 2 that points downward in the rest position 34.

FIG. 2 shows a fragmented view in the direction onto the top side 36 of the housing 2. The work apparatus 1 has heaters 12 and 13 (FIG. 1) for the handles 3 and 4. A first heater 12 is provided for the second handle 4 and visible in FIG. 2. A second heater 13 is provided for the first handle 3 and schematically illustrated in FIG. 1. For actuating the heaters 12 and 13, the work apparatus 1 has a first control unit 14 schematically illustrated in FIG. 2. A second control unit 15 is provided for actuating the drive motor 8. The second control unit 15 is configured separately from the first control unit 14. The control units 14 and 15 are disposed so as to be spatially separated in the housing 2. The control units 14 and 15 are control modules which are configured separately from one another. In particular, the control units 14 and 15 are able to be inserted into the housing 2 and removed therefrom independently of one another. The control unit 15 is advantageously capable of functioning with a control unit 14 or without the latter. The control units 14 and 15 are in particular disposed in spaces in the housing 2 of the work apparatus 1 that are at least partially separated from one another. The control units 14 and 15 are in particular cooled separately from one another. For this purpose, it is provided in particular that a cooling air flow first flows by way of one of the control units, in particular by way of the control unit 15, and then by way of the other one of the control units, in particular by way of the control unit 14. By suitably disposing the control units 14 and 15 and configuring a transfer opening for cooling air between the spaces in which the control units 14 and 15 are disposed, a desired cooling effect for each of the control units 14 and 15 can thus be set in a simple manner.

As shown in FIGS. 1 and 2, the second handle 4 includes a section 35 which engages across the top side 36 of the housing 2 at a spacing from the latter. As a result, the operator can grip the section 35 of the second handle 4, adjacent to the top side 36 of the housing 2, across the entire circumference of the second handle 4.

For actuating the heaters 12 and 13, the work apparatus 1 has a switch 19. The switch 19 is disposed on the top side 36 of the housing 2, as is shown in FIG. 2. The switch 19 herein in the embodiment is disposed close to a longitudinal side 30 of the housing 2. The longitudinal side 30 of the housing 2 is the side on which a sprocket wheel cover 44 of the work apparatus 1 is disposed. The sprocket wheel cover 44 clamps the guide bar 10 and covers a drive pinion, not illustrated, which serves to drive the saw chain 11. The guide bar 10 and the saw chain 11 are disposed so as to be adjacent to the longitudinal side 30.

As is shown in FIG. 2, the switch 19 is disposed close to the section 35 of the second handle 4. When viewed from above onto the work apparatus 1, the switch 19 has a spacing a from the section 35, which is in particular less than 5 cm, especially in particular less than 3 cm. It can also be provided that the switch 19 extends into a region below the section 35 in such a way that the spacing a is zero. The spacing a is measured in the view from above onto the work apparatus 1 illustrated in FIG. 2. The view from above herein is the viewing direction perpendicularly downward onto the work apparatus 1 standing on the rest surface 33. The switch 19 is disposed in such a way that it is readily visible and accessible by the user.

The switch 19 in the embodiment is configured as a rocker switch which has at least two, in particular at least three, switch positions. One switch position here is assigned to the switched-off state of the heaters 12 and 13, and at least one further switch position is assigned to the switched-on state of the heaters 12 and 13. In particular, at least two switch positions are assigned to the switched-on state of the heaters 12 and 13 with different target temperatures Te1 and Te2. Different target temperatures Te1 and Te2 of the heaters are illustrated in FIG. 4.

Any other configuration embodiment of the switch 19 can be advantageous. For example, the switch 19 can alternatively also be configured as a rotary switch, so as to switch or regulate the heating power and/or the target temperature Te, Te1, Te2 according to a rotational position of the rotary switch.

For actuating the heaters 12 and 13, the work apparatus 1 includes a connecting unit 37 which is schematically illustrated in FIG. 2. The connecting unit 37 can be part of the first control unit 14 or part of the second control unit 15, or be configured separately from the control units 14 and 15. The connecting unit 37 is configured to establish a wireless data connection 39 to an external device 38. The wireless data connection 39 in FIG. 2 is illustrated by a broken line. The external device 38 can be, for example, a smartphone, a tablet, or a similar mobile device. The external device 38 can also be a stationary device such as a PC, for example. A program which enables communication with the connecting unit 37 and permits at least one of the heaters 12 and/or 13 to be actuated is in particular installed on the external device 38.

The at least one heater 12 and/or 13 can in particular be switched on and/or switched off by way of the external device 38. Alternatively or additionally, it is provided in particular that one or a plurality of target temperatures Te, Te1, Te2, which are in particular individual to the operator, for the at least one heater 12 and/or 13 can be set by way of the external device 38. The target temperature Te, Te1, Te2 set by the operator is in particular transmitted to the work apparatus 1 by way of the data connection 39, as is schematically illustrated in FIG. 2. Alternatively or additionally, setting one or a plurality of target temperatures Te for the heater 12 and/or 13 is possible by way of the switch 19. The switch 19 and the connecting unit 37 can be provided alternatively or in addition to one another. Alternatively or additionally, it can be provided that the data connection 39 is established by a data cable.

FIG. 2 also shows the construction of the first heater 12. The first heater 12 includes a heating foil 16 which is applied to a base body 24 of the second handle 4. The base body 24 is in particular a dimensionally stable carrier body. The base body 24 can in particular be composed at least partially, in particular completely, of metal, especially particularly of an aluminum alloy. The base body 24 is in particular an aluminum tube. As is shown in FIG. 2, the heating foil 16 has a connecting section 20. A connecting point 23, for example a soldered point, to which connecting lines 18 for supplying the heating foil 16 with electric energy are connected, is provided at the end of the connecting section 20.

As is also shown in FIG. 2, the heating foil 16 includes a sensor section 21. A temperature sensor 17 which measures the temperature of the heating foil 16 is fixedly established on the heating foil 16. The temperature sensor 17 is disposed on the sensor section 21. As is shown in FIG. 2, a slit 22 which spatially separates the connecting section 20 and the sensor section 21 from one another is formed between the connecting section 20 and the sensor section 21. Owing to the fact that the temperature sensor 17 is not disposed directly adjacent to the connecting section 20, the external temperature of the handle can be more precisely estimated.

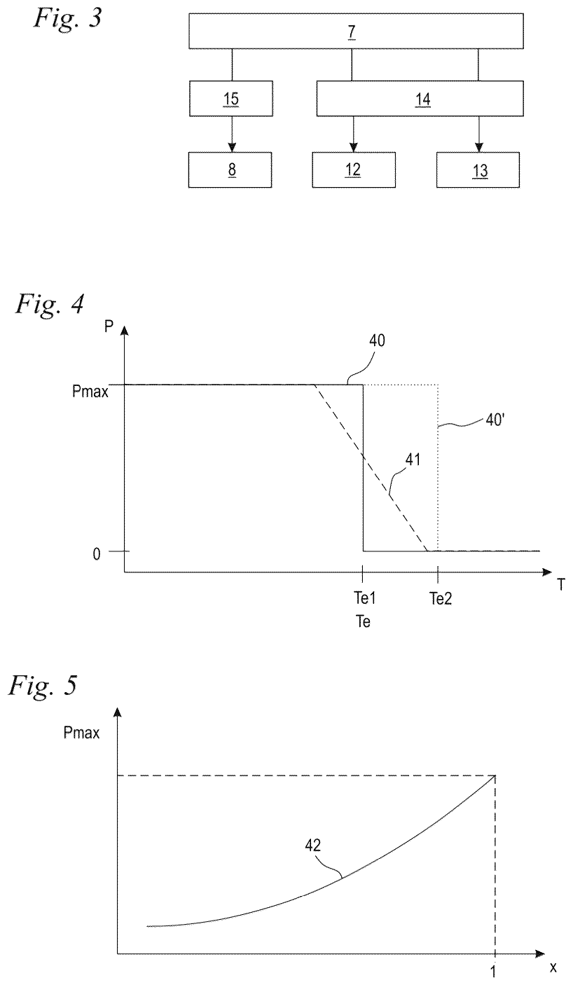

FIG. 3 schematically shows the actuation and the energy supply of components of the work apparatus 1. The energy store 7 serves as an energy supply. The energy store 7 supplies the drive motor 8, the first heater 12 and the second heater 13 with energy. The electric power supplied to the drive motor 8 is set by the second control unit 15 as a function of the position of the operator controlled element 5. The electric power made available to the heaters 12 and 13 is controlled by the first control unit 14. In particular, the heaters 12 and 13 are operated directly with the output voltage of the energy store 7. If the amount of energy stored in the energy store 7 decreases, the output voltage of the energy store 7 decreases, and the maximum power Pmax (FIG. 4) made available to the at least one heater 12 or 13 drops accordingly.

FIG. 4 shows the power made available to the at least one heater 12 or 13 as a function of the target temperature Te set by the operator. In the diagram of FIG. 4, the heaters 12 and/or 13 can be supplied with a maximum electric power Pmax made available as long as the temperature measured by the temperature sensor 17 lies below a target temperature Te. If the measured temperature T exceeds the target temperature Te, the electric power made available to the at least one heater 12 and/or 13 is lowered to zero. This is highlighted by a line 40 in FIG. 4. The target temperature Te can in particular be a temperature set by an operator.

A two-position controller can in particular be provided for operating the at least one heater. The at least one heater 12, 13 is supplied with a heating power until the temperature determined by the at least one temperature sensor 17 exceeds a first temperature limit value. The heating power is subsequently switched off until a second temperature limit value is undershot. The second temperature limit value here lies below the first temperature limit value. When the second temperature limit value is undershot, the at least one heater is supplied with heating power again until the temperature T increases beyond the first temperature limit value again. In this way, the temperature T can easily be maintained between the first and the second temperature limit value.

The heating power can be the maximum power Pmax. Alternatively, a mean power Pm, which is diminished in comparison to the maximum power Pmax, can be made available. The diminished, mean power Pm can be generated by switching on and switching off the heater 12, 13, for example by pulse width modulation. The power supplied to the at least one heater 12, 13 in terms of its mean value is in particular always identical during initial heating as well as in later operation.

Alternatively, the electric power can be gradually reduced, as is schematically illustrated by the broken line 41. The position of the obliquely running section of the line 41 in terms of the target temperature Te can be suitably chosen and also be at lower or higher temperatures T than schematically illustrated in FIG. 4.

Alternatively, if a first target temperature Te1 or a second target temperature Te2 can be set by the operator, it is provided in particular that the power P made available to the at least one heater 12 and/or 13 at a set target temperature Te1 is set after the line 40, and at a set target temperature Te2 is set after the dotted line 40′. The profile illustrated by the line 41 is accordingly also possible in the case of a plurality of target temperatures Te1 and Te2 that are able to be set.

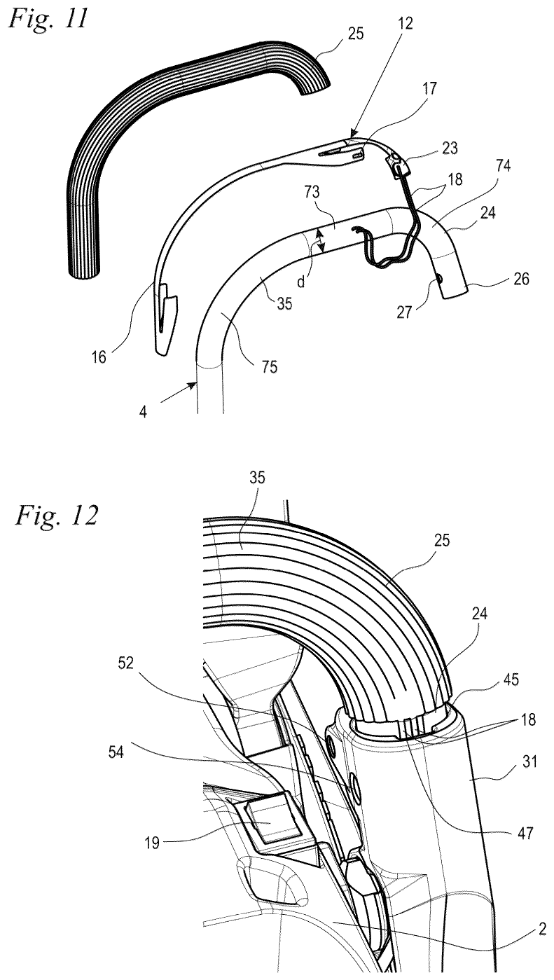

The maximum power Pmax made available is in particular controlled or established by the control unit 14. The at least one heater 12 and/or 13 is in particular operated directly with the output voltage of the energy store 7. FIG. 5 schematically shows the maximum power made available to the at least one heater 12, 13 over the charging state x of the energy store 7. The charging state x herein indicates the energy currently stored in the energy store 7 divided by the maximum energy that is able to be stored in the energy store 7. The maximum power Pmax made available to the at least one heater 12, 13 is the highest in the case of a charging state x of 1. As the charging state x drops, the maximum power Pmax made available to the at least one heater 12, 13 is reduced, as is schematically shown by the line 42 in FIG. 5. The maximum power Pmax made available to the at least one heater 12, 13 is reduced by the control unit 14 in particular as a function of further factors such as in particular the temperature measured by a temperature sensor 17 (FIG. 11) and/or the target temperature Te set by an operator.

The control unit 14 can be configured to switch off the at least one heater 12 and/or 13 if a target temperature Te, Te1, Te2 at the temperature sensor 17 is reached or exceeded by a predefined value. It is additionally provided in particular that the heater 12 and/or 13 is switched off if a predefined upper limit of the temperature is reached, which lies above the highest target temperature Te or Te2 that is able to be set. It can also be provided that the heaters 12 and/or 13 are switched off when a malfunction is identified, for example a broken cable. It is provided in particular that the control unit 14 switches on the at least one heater 12 and/or 13 if the target temperature Te, Te1, Te2 is undershot by a predefined value.

It can be provided in particular that the first heater 12 and/or the second heater 13 are/is switched off in the case of a high energy requirement of the drive motor 8. This can take place in particular in a so-called boost mode, an operation of the work apparatus 1 with a briefly higher power output. Alternatively or additionally, switching off the first heater 12 and/or the second heater 13 can take place in a particularly economical operating mode, for example a so-called ECO mode.

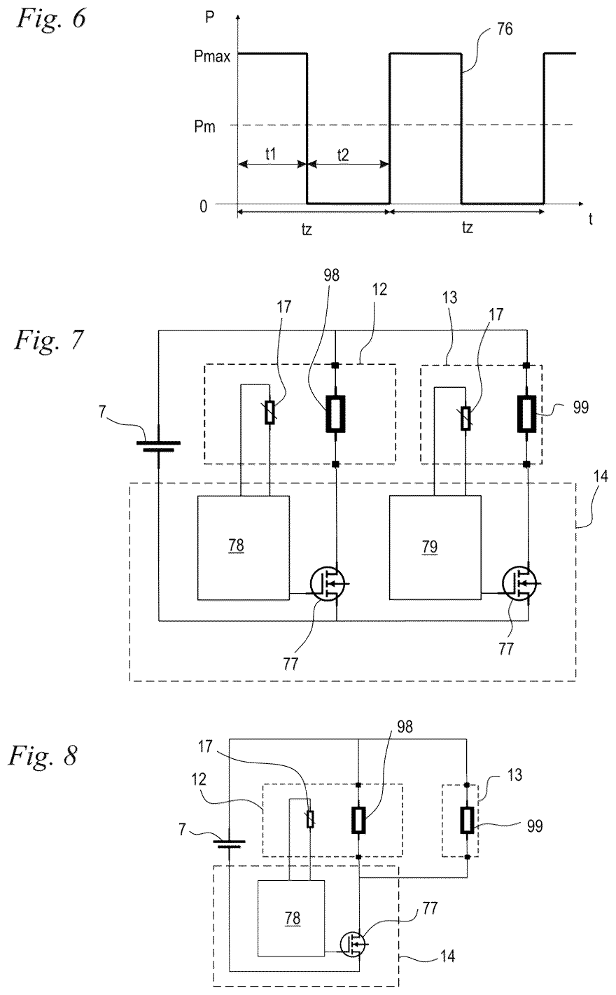

The control unit 14 feedback-controls in particular the temperature of the heating element of the at least one heater 12 and/or 13 to the target temperature Te, Te1, Te2 set by the operator. As is schematically illustrated in FIG. 6, for this purpose the control unit 14 can make available to the at least one heater 12 and/or 13 a mean electric power Pm which is less than the maximum power Pmax made available. For this purpose, it is provided in particular that the control unit 14 within a temporal interval tz makes available to the at least one heater 12 and/or 13 the maximum electric power Pmax made available over a duration t1, and does not make available any electric power over a duration t2. As a result, operating the at least one heater 12 and/or 13 with a mean electric power Pm is easily possible. This is schematically illustrated by a line 76 in FIG. 6. The size of the mean power Pm can be set by varying the durations t1 and t2. This can be performed by pulse width modulation, for example.

In particular, the control unit 14 actuates the two heaters 12 and 13 separately from one another. This is schematically illustrated in FIG. 7. Alternatively, the control unit 14 can conjointly actuate both heaters 12 and 13, as is illustrated in FIGS. 8 to 10.

In the embodiment according to FIG. 7, the control unit 14 includes a first control unit 78 and a transistor 77 for actuating the first heater 12. The transistor 77 in the embodiment is a MOSFET (metal oxide semiconductor field effect transistor), in particular a (self-blocking) n-channel MOSFET (enhancement type field effect transistor). Any other configuration embodiment of the transistor 77 can also be advantageous.

The heating element of the first heater 12, in particular a conductor applied to the heating foil 16, is illustrated by way of its ohmic resistor 98 in FIG. 7. The first control unit 78 of the control unit 14 by way of the transistor 77 feedback-controls the mean electric power Pm at which the resistor 98 is operated as a function of the temperature T measured by the temperature sensor 17 of the first heater 12. The voltage supply takes place by way of the energy store 7.

The control unit 14 includes a second control unit 79 and a further transistor 77. The further transistor 77 can also be configured as an n-channel MOSFET, or be of any other construction. The second heater 13 has an ohmic resistor 99. The second control unit 79 feedback-controls the mean electric power Pm with which the resistor 99 is supplied as a function of the temperature T measured by the temperature sensor 17 of the second heater 13.

In the embodiment according to FIG. 8, both heaters 12 and 13 are supplied by a common control unit 78 with electric power P by way of a common transistor 77, specifically as a function of the temperature T measured by the temperature sensor 17, in particular the temperature sensor 17 of the first heater 12. Alternatively, it can be provided that the heater 13 has the temperature sensor 17. The resistors 98 and 99 of the heaters 12 and 13 are wired in parallel in FIG. 8.

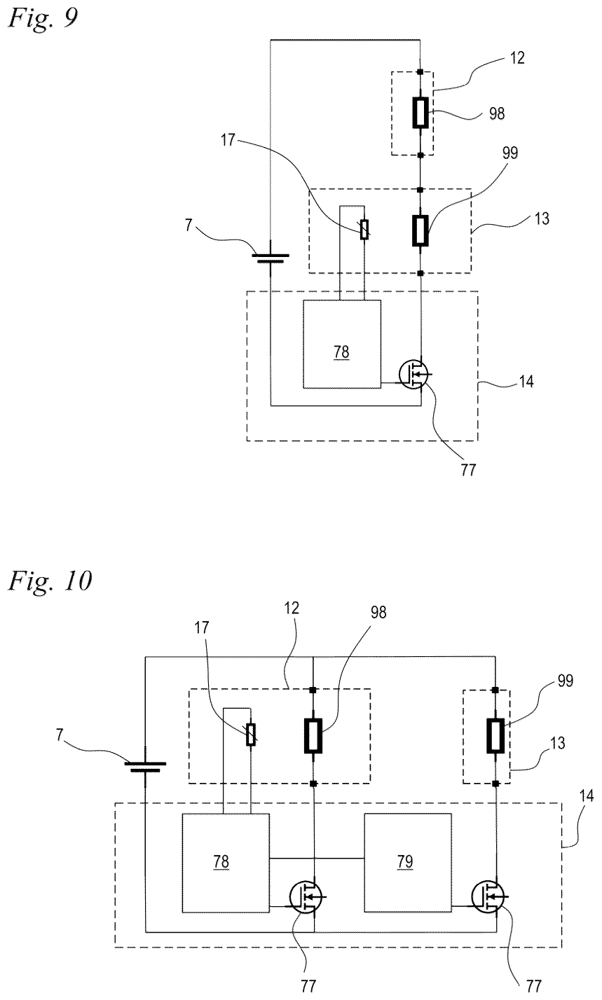

FIG. 9 shows an embodiment in which both heaters 12 and 13 are supplied with electric power P by way of a common control unit 78 and a common transistor 77. In the embodiment according to FIG. 9, both heaters 12 and 13, presently the ohmic resistors 98 and 99 of the heaters 12 and 13, are wired in series. In the embodiment according to FIG. 9, the heater 13 has the temperature sensor 17, and the heater 12 does not have any temperature sensor 17. However, it can also be provided in the arrangement according to FIG. 9 that the temperature sensor 17 is disposed on the first heater 12, and no temperature sensor 17 is provided on the heater 13.

In the embodiment according to FIG. 10, two control units 78 and 79 are provided, each actuating one transistor 77. The heater 13 in the embodiment does not have a dedicated temperature sensor 17. The control unit 79 is coupled to the control unit 78, for example for transmitting the temperature value measured by the temperature sensor 17, or for transmitting a signal which correlates with the mean power Pm to be set. Owing to the fact that separate control unit 78 and 79 are provided for the heaters 12 and 13, the heaters 12 and 13 can be operated with different mean electric powers Pm. As a result, different heating properties of the heaters 12 and 13 can be taken into account, for example, without a further temperature sensor 17 being required on the second heater 13.

In the embodiment according to FIG. 10, it can alternatively be provided that the heater 13 has the temperature sensor 17, and the control unit 78 is actuated by the control unit 79.

The maximum power Pmax made available is in particular the maximum power conjointly available to both heaters 12 and 13. If one of the heaters 12 or 13 is already heated to the target temperature Te, the other one of the heaters 13 or 12 can thus be operated with the entire maximum power Pmax made available for the heaters 12 and 13. If both heaters 12 and 13 are not yet heated to their target temperature Te, Te1, Te2, it is provided in particular that the control unit 14 divides the maximum power Pmax made available among both heaters 12 and 13.

It can be provided that the operator can set a common target temperature Te, Te1, Te2 for both heaters 12 and 13. Alternatively, it can be provided that the target temperatures Te, Te1, Te2 for both heaters 12 and 13 are able to be set independently of one another. It can be provided that the two heaters 12 and 13 are able to be switched on independently of one another. The independent actuation of two or more heaters 12, 13 is easily possible in particular if the actuation of the heaters 12 and 13 by the operator takes place by way of an external device 38.

FIG. 11 shows the arrangement of the first heater 12 on the base body 24 of the second handle 4. The heating foil 16 extends in particular over the entire section 35 and in particular also over the section 35. The temperature sensor 17 is disposed at or on the heating foil 16. The base body 24 has an external diameter d. The second handle 4 has a covering 25 which can be composed of an elastic plastics material or rubber, for example, and which in particular largely surrounds the base body 24 and the heater 12. In particular, the covering 25 completely covers the heating foil 16 up to the connecting point 23, in particular including the connecting point 23. Only the connecting lines 18 of the first heater 12 preferably protrude from the covering 25.

The second handle 4 has a first end region 26. In the embodiment, the connecting lines 18 protrude from the covering 25 so as to be adjacent to the first end region 26. The base body 24 has an opening 27 in the first end region 26, the opening yet to be described in more detail hereunder. The first end region 26 extends in particular on that longitudinal side 30 of the work apparatus 1 on which the sprocket wheel cover 44 is also disposed, as is derived from FIGS. 2 and 11.

As is shown in FIG. 11, the base body 24 has a straight section 73 which in the rest position 34 (FIG. 1) runs above the housing 2 of the work apparatus 1, as is also shown in FIG. 2. In the embodiment, the section 35, which engages across the top side 36 of the housing 2 at a spacing from the latter (FIGS. 1 and 2), includes the straight section 73. Curved sections 74 and 75 adjoin the straight section 73, as is shown in FIG. 2 and FIG. 11. A central axis of the handle 4 runs so as to be bent in the curved sections 74 and 75. As is shown in FIG. 2 and FIG. 11, the heating foil 16 having the temperature sensor 17 is disposed on the base body in such a way that the temperature sensor 17 is disposed on a curved section 74 of the base body 24. In the embodiment, the section 35 includes parts of the curved sections 74 and 75.

A first fastening adapter 31, which is illustrated in fragments in FIG. 12, is provided for fixing the first end region 26 to the housing 2 of the work apparatus 1. The first end region 26 (FIG. 11) protrudes into a receiver 45 of the first fastening adapter 31. The connecting lines 18 are also routed in the fastening adapter 31. For this purpose, the fastening adapter 31 has a cutout 47 on the receiver 45. As is also shown in FIG. 12, the fastening adapter 31 includes a screw dome 52 and a position securing opening 54 which is yet to be described in more detail hereunder.

FIG. 12 also shows the position of the switch 19 approximately below the section 35 of the second handle 4.

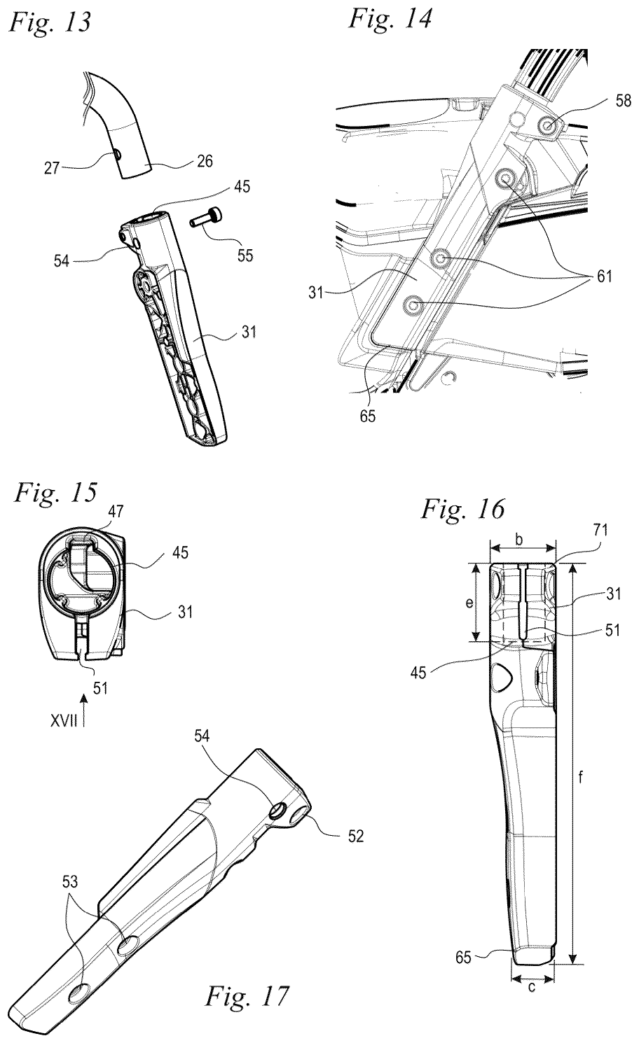

FIG. 13 shows the fastening adapter 31 and the first end region 26 in a perspective exploded illustration. Provided is a position securing element 55 which in the embodiment can be configured as a bolt or screw. When the first end region 26 is inserted into the receiver 45, the opening 25 thus comes to lie so as to superimpose the position securing opening 54. The position securing opening 54 in the embodiment is configured as a through-opening. The position securing element 55 can be inserted into the position securing opening 54 and in particular be firmly screwed to the position securing element 55 in the position securing opening 54. As a result, the first end region 26 is fixed in the longitudinal direction of the base body 24 in the fastening adapter 31.

The fastening adapter 31 is configured in one part in the embodiment. A configuration embodiment of the fastening adapter 31 in multiple parts may also be advantageous. The fastening adapter 31 is composed in particular at least partially, in particular largely, especially particularly completely, of metal, in particular of light metal, for example of magnesium or aluminum. The fastening adapter 31 is in particular produced by a die-casting method. Alternatively, it can be provided that the fastening adapter 31 is partially or completely composed of plastics material.

As is shown in FIG. 14, a clamping screw 58 is screwed into the fastening adapter 31. As is shown in FIG. 15, the fastening adapter 31 has a clamping slit 51 which extends into the receiver 45. The cutout 47 for the connecting lines 18 is also illustrated in FIG. 15. When the clamping screw 58 (FIG. 14) is tightened, the clamping slit 51 is compressed and the internal diameter of the receiver 45 is reduced as a result. In this way, the first end region 26 is held so as to be clamped in the receiver 45.

As is also shown in FIG. 14, the fastening adapter 31 is fastened to the housing 2 of the work apparatus 1 by a plurality of fastening screws 61; three fastening screws 61 are provided on the first fastening adapter 31 in the embodiment. In the embodiment, the first fastening adapter 31 is disposed on the longitudinal side 30 of the housing 2. The receiver 45 is schematically plotted in FIG. 14. As is shown in FIG. 14, the fastening screws 61 are disposed below the receiver 45, thus in a region of the fastening adapter 31 in which the base body 24 of the second handle does not extend. As a result, the position of the fastening screws 61 can be flexibly chosen.

The position of the fastening screws 61 is in particular chosen so as to be congruent with the position of fastening screws for an alternative second handle which is formed completely of plastics material. As a result, the handle 4 with a metallic base body 24 and the heater 12, illustrated in the figures, or a handle produced completely from plastics material, can alternatively be fixed to the housing 2 of the work apparatus 1. Owing to the fact that the control units 14 and 15 are configured as separate control modules, the production of a work apparatus 1 with a heater, or alternatively the production of a work apparatus without a heater, is easily possible while using identical housing parts.

A screw dome 52 for the clamping screw 58, the position securing opening 54 and two of the fastening openings 53 for the fastening screws 61 are plotted in FIG. 17.

As is shown in FIG. 16, the first fastening adapter 31, at an upper end 71 in which the first end region 26 is to be disposed, has a width b which is greater than the diameter of the base body 24 plotted in FIG. 11. The fastening adapter 31, at a lower end 65 of the first fastening adapter 31 which lies at a minor spacing from the bottom side 50 of the housing 2, has a width c which is smaller than the width b. The width c is in particular smaller than the external diameter d of the base body 24.

The fastening adapter 31 has a length f. The length f is significantly greater than a length e of the receiver 45. The lengths e and f are measured parallel to one another and in the longitudinal direction of the end region 26. Owing to the great length f, it is possible to dispose the fastening screws 61 (FIG. 14) at a comparatively large mutual spacing, so that positive fixing of the first fastening adapter 31 to the housing 2 is possible. At the same time, the width of the work apparatus 1 can be kept comparatively small in the region of the fastening adapter 31, without forming of the base body 24 of the handle 4 at the end region 26 being necessary.

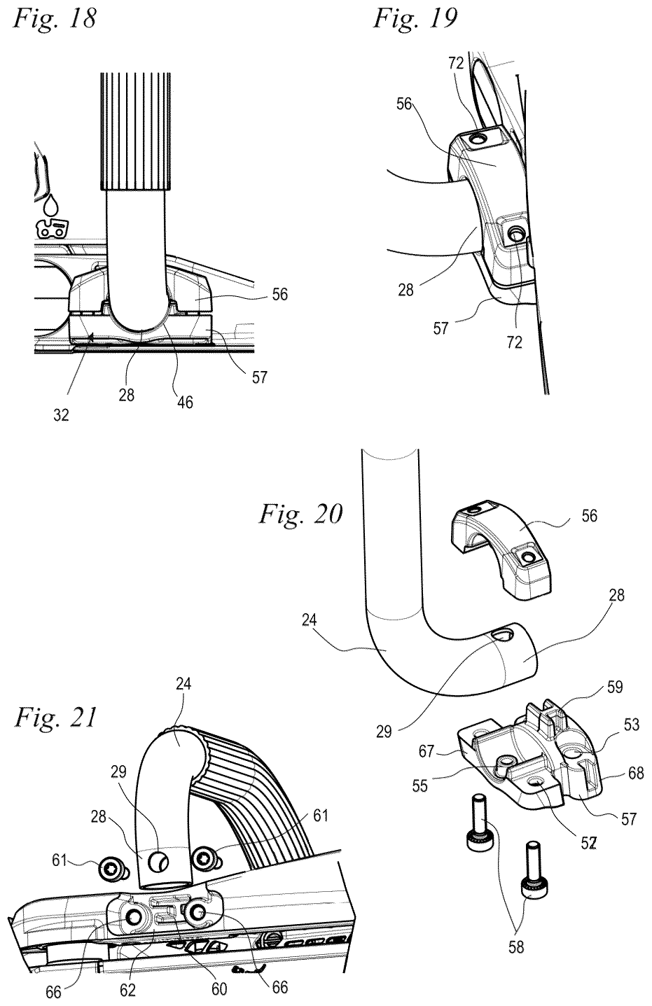

FIGS. 18 to 25 show the configuration embodiment of a second fastening adapter 32 by way of which a second end region 28 of the base body 24 is fixedly established on the housing 2. The end regions 26 and 28 in the embodiment describe the ends of the metal tube that forms the base body 24.

FIG. 18 shows the arrangement of the second end region 28 in a receiver 46 of the second fastening adapter 32. The second fastening adapter 32 is in particular configured in two parts and includes an upper part 56 and a lower part 57. In the rest position 34, the upper part 56 is disposed above the lower part 57 in spatial terms.

As is shown in FIG. 19, the upper part 56 has clamping openings 72. As is shown in FIG. 20, the lower part 57 also has clamping openings 72. Two clamping screws 58 which in terms of the rest position 34 are inserted through the lower part 57 from below and screwed into the upper part 56 are provided in the embodiment. As a result, the end region 28 can be fixed so as to be clamped between the upper part 56 and the lower part 57.

As is shown in FIG. 20, the end region 28 has an opening 29. A position securing element 55 on the lower part 57 is shown in FIG. 20. The position securing element 55 is formed as a stud which is integrally molded on the lower part 57 and protrudes into the opening 29. As is also shown in FIG. 20, the lower part 57 has fastening openings 53 of which one is visible in FIG. 20. The lower part 57 has an elevation 59 which in the embodiment has approximately the shape of a raised H.

The lower part 57 in the embodiment is formed from two sections 67 and 68. The section 67 is provided to be disposed next to the housing 2 when viewed from above onto the work apparatus 1 in the rest position 34. The second section 68 is provided to be disposed on the lower side 50 of the work apparatus 1 and not visible when the work apparatus is disposed in the rest position 34. As is shown in FIG. 21, the housing 2 has a receiver 62. The receiver 62 serves to receive the second section 68 of the lower part 57.

The second section 68 is in particular disposed completely in the receiver 62. The receiver 62 has a recess 60 which has the shape of an H and is provided to receive the elevation 59. The elevation 59 and the recess 60 form a form-fitting positional safeguard in all directions, in particular in a plane which in the rest position 34 runs horizontally and parallel to the rest surface 33.

As is shown in FIG. 21, screw domes 66, into which fastening screws 61 for fixing the lower part 57 to the housing 2 are to be screwed, are provided in the receiver 62. Other types of fastening can also be provided. For example, fastening can be provided by way of one or a plurality of rivets, or by way of an adhesive. The lower part 57 has fastening openings 53 which are shown in FIG. 20 and protrude through the fastening screws 61 illustrated in FIG. 21. The upper part 56 is fixed with clamping screws 58 on the first section 67 of the lower part 57. In the process, the clamping screws 58 also clamp the second end region 28 of the base body 24 of the handle 4. As is shown in FIG. 20, the clamping screws 58 are screwed into the upper part 56 from below in terms of the rest position 34.

Owing to being positionally secured in a form-fitting manner by way of the elevation 59 and the recess 60, the second section 68 is only slightly displaceable in the receiver 62, particularly only in the magnitude of the manufacturing tolerances, or not displaceable, in terms of all horizontal directions in the rest position 34, even when the fastening screws 61 are not fixed.

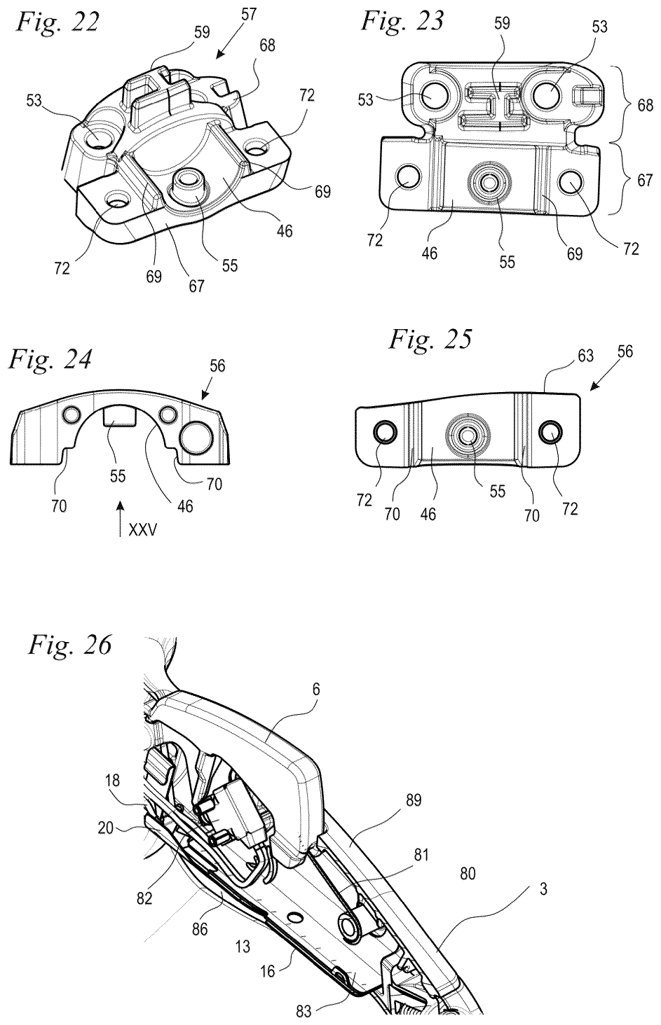

As is shown in FIGS. 22 to 25, sections of the receiver 46 are in each case formed on the lower part 57 and on the upper part 56.

The lower part 57 has a position securing element 55 which protrudes into the assigned opening 29 of the second end region 28. Ribs 69 are provided in the lower part 57 for positionally securing the lower part 57 and the upper part 56 in relation to one another (FIGS. 22 and 23). As is illustrated in the embodiment, the ribs 69 can delimit the receiver 46. The ribs 69 protrude into recesses 70 of the upper part 56 (FIGS. 24 and 25) and in this way establish the position of the upper part 56 in relation to the lower part 57.

As is shown in FIG. 25, the lower part 57 on the side facing the housing 2 has an outer contour 63 which is adapted to an outer contour of the housing 2 in this region. The outer contour 63 does not run straight, but is angled and/or bent. In particular, the outer contour 63 adjoins the housing 2 tightly.

FIGS. 26 to 32 show the configuration embodiment of the second heater 13 in detail.

The second heater 13 is disposed in an interior space 80 of the first handle 3. The second operator controlled element 6 protrudes into the interior space 80. The first operator controlled element 5, which is not illustrated in FIG. 26, also protrudes into the interior space 80. As is shown in FIG. 26, the second operator controlled element 6 is pre-loaded by a spring 81. A switch 82, in particular a microswitch, which is to be activated by the first operator controlled element 5 in order to actuate the drive motor 8 (FIG. 1) can be disposed in the interior space 80.

The interior space 80 is closed by a cover part 89. The operator controlled element 6 in the embodiment protrudes through the cover part 89. Any other arrangement of the cover part 89 can however also be advantageous. A configuration embodiment without the cover part 89 can also be advantageous.

As is shown in FIG. 26, the second heater 13 is disposed in the interior space 80 of the second handle 3. The second heater 13 includes a carrier 83. The carrier 83 is in particular formed at least partially, in particular completely, from metal, in particular from aluminum or an aluminum alloy. The carrier 83 in the embodiment is formed as a thin metal sheet. In an alternative variant of embodiment it can be provided that the carrier 83 is composed at least partially, in particular completely, of plastics material. The heating foil 16 which forms the heating element is held on the carrier 83. An elastic layer 84 is disposed between the carrier 83 and the heating foil 16. The carrier 83 and the elastic layer 84 press the heating foil 16 against an inner surface 86 of the handle 3. Tolerances of the inner surface 86 of the handle 3 can be compensated for by the elastic layer 84. As a result, it can be easily achieved that the heating foil 16 positively rests on the inner surface 86.

The elastic layer 84 has an insulating effect. A thermal transfer of the heat generated by the heater 13 in the direction of the carrier 83 is avoided by the insulating effect of the elastic layer 84. In other words, a thermal transfer of the heat generated by the heater 13 is directed in the direction of the inner surface 86 of the handle by the insulating effect of the elastic layer 84.

The elastic layer 84 is in particular an elastic plastics material, in particular an expanded plastics material. The elastic layer 84 can be a rubber material. The elastic layer 84 is compressible and in the absence of a compressive force acting thereon returns to its initial shape.

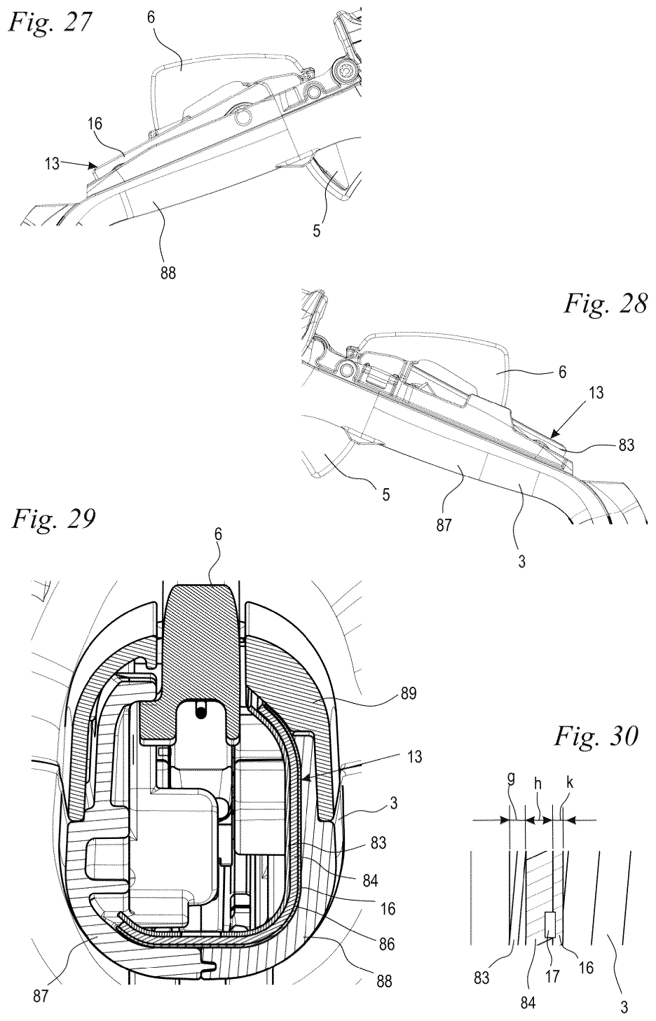

FIG. 27 shows a lateral view onto a handle shell 88 of the handle 3. FIG. 28 shows a view onto an opposite handle shell 87 of the handle 3. The handle shells 87 and 88 are also illustrated in the sectional illustration in FIG. 4. The handle shells 87 and 88 form a lower region of the handle 3 in terms of the rest position 34 (FIG. 1), the lower region being closed by the cover part 89 toward the top. As is shown in FIG. 27, the heater 13 protrudes beyond the handle shell 88 into the region that can be closed by the cover part 89. Alternatively, the handle 3 can be configured without a cover part 89. The handle 3 can be constructed from two handle shells 87 and 88, for example. This can also be seen in FIG. 29. The carrier 83 of the heater 13 is visible in the illustration in FIG. 28. The region of the heater 13 which rests on the handle shell 88 can be seen in FIG. 28.

As is shown in FIG. 29, the heater 13 rests on the inner surface 86 of the handle 3 in the lower region of the handle 3. Moreover, the heater 13 rests on the side on the inner surface 86 of the handle 3 that is illustrated on the right in FIG. 29. The heater 13 rests on both handle shells 87 and 88 and on the cover part 89. Mounting parts which protrude into the interior space 80 of the handle 3 are disposed on the opposite side. The heater 13 is cut out in this region.

FIG. 30 shows the construction of the heater 13 in detail. The heater 13 includes the carrier 83. The carrier 83 has a thickness g. The thickness g is in particular the maximum thickness g of the carrier 83 in a region that is covered by the heating foil 16. The thickness g is measured in particular in a region of the carrier 83 that is covered by the elastic layer 84. In particular, the thickness g of the carrier 83 is constant in the region that is covered by the elastic layer 84.

The thickness g of the carrier 83, in particular at least in one region of the carrier 83, in particular over at least 50% of the area of the region of the carrier 83 covered by the elastic layer 84, in particular over at least 80% of the area of the region covered by the elastic layer 84, is at least 0.1 mm, in particular at least 0.2 mm. The thickness g of the carrier 83, in particular at least in one region, in particular over at least 50%, in particular over at least 80%, of the area of the region covered by the elastic layer is at most 1 mm, in particular at most 0.8 mm. Any other thickness g of the carrier 83 can however be advantageous. Another thickness g can be advantageous in particular if the carrier 83 is not of metal.

The elastic layer 84 is fixedly established on the carrier 83. The elastic layer 84 has a thickness h. The thickness h is in particular the minimum thickness h of the elastic layer 84 in a region that is covered by the heating foil 16. The thickness h is in particular measured in a region of the elastic layer 84 that lies between the carrier 83 and the heating foil 16. In particular, the thickness h is largely constant in the region that is covered by the heating foil 16. In particular, the thickness h is constant in the region that is covered by the heating foil 16. The thickness h is greater than the thickness g. The thickness h is in particular at least twice the thickness g. As a result, the elastic layer 84 can positively compensate for tolerances.

The thickness h of the elastic layer 84 can in particular be at least 0.3 mm, in particular at least 0.5 mm. The thickness h of the elastic layer 84 can in particular be at most 2 mm, in particular at most 1.5 mm, in particular at most 1.0 mm. The thickness h in the embodiment is approximately 0.8 mm.

The thermal conductivity λ of the elastic layer 84 is in particular less than 1 W/(mK), in particular less than 0.5 W/(mK). The elastic layer 84 is composed in particular largely, in particular completely, of plastics material, in particular of expanded plastics material. The elastic layer 84 is composed in particular largely, in particular completely, of polyethylene (PE), in particular of expanded polyethylene (PE).

The heating foil 16 is fixedly established on the elastic layer 84 on the side of the elastic layer 84 that lies opposite the carrier 83. The heating foil 16 has a thickness k. As is shown in FIG. 30, the thickness k is smaller than the thickness h of the elastic layer 84. The thickness h of the elastic layer 84 is in particular at least twice the thickness k of the heating foil 16. FIG. 30 also shows the positioning of a temperature sensor 17 disposed on the heating foil 16. The temperature sensor 17 of the heater 13 is disposed on the side of the heating foil 16 that faces the elastic layer 84. The temperature sensor 17 lies between the heating foil 16 and the elastic layer 84. The elastic layer 84 is compressed in the region of the temperature sensor 17. The enlarged thickness of the assembly consisting of the heating foil 16 and temperature sensor 17 in the region of the temperature sensor 17 is compensated for by the elastic layer 84. Owing to the fact that the temperature sensor 17 is disposed on the heating foil 16, it is possible to precisely detect the temperature actually prevailing on the heating foil 16. Owing to the fact that the temperatures sensor 17 is disposed on the side of the heating foil 16 that faces the elastic layer 84, it can be achieved that the heating foil 16 rests uniformly on the inner surface 86 of the handle 3.

The term gauge g, h, k can alternatively be used for the term thickness g, h, k.

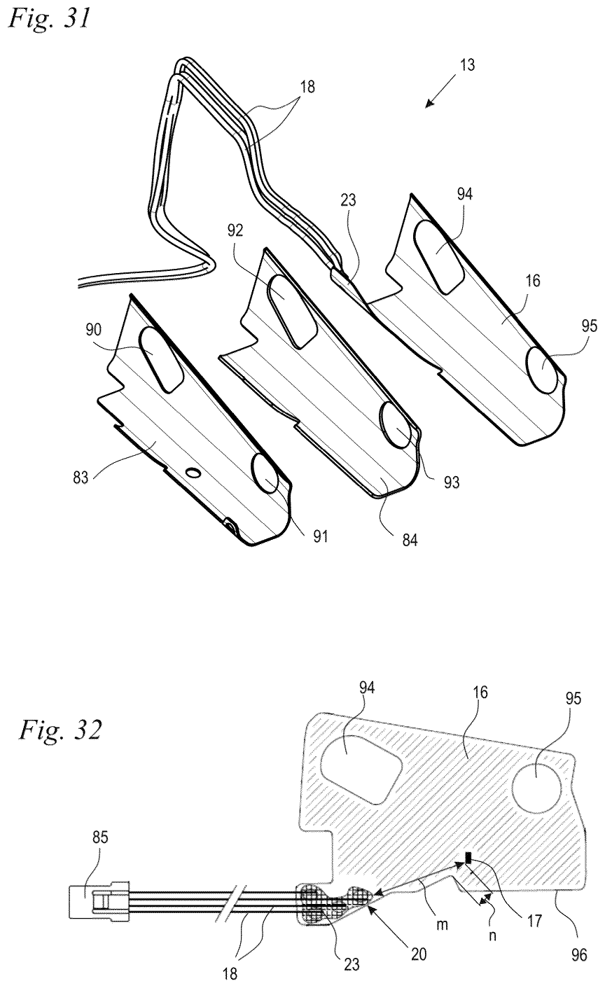

FIG. 31 shows the heater 13 in an exploded illustration. As is shown in FIG. 31, the carrier 83 has a cutout 90 and a cutout 91. The elastic layer 84 has a cutout 92 and a cutout 93. The heating foil 16 has a cutout 94 and a cutout 95. The cutouts 90, 92 and 94 lie in particular so as to be approximately congruent on top of one another. The cutouts 91, 93 and 95 lie in particular so as to be approximately congruent on top of one another. The cutouts 90 to 95 generate space in particular for elements of the handle 3 that protrude into the interior space 80 of the handle 3.

The carrier 83 covers the elastic layer 84 in particular over at least 80%, in particular over at least 90%, of the area of the elastic layer 84. The carrier 83 in particular covers the elastic layer 84 completely. The elastic layer 84 covers the heating foil 16 in particular over at least 80%, in particular at least 90%, of the area of the heating foil 16. In particular, the heating foil 16 protrudes beyond the elastic layer 84 only in the region of the connecting point 23, at which the connecting lines 18 are fixedly established on the heating foil 16.

FIG. 32 shows the configuration embodiment of the heating foil 16 and the arrangement of the temperature sensor 17 and the arrangement of the connecting point 23 on the heating foil 16. The temperature sensor 17, conjointly with the heating foil 16, is disposed on the handle 3, specifically in the handle 3. The disposal of the temperature sensor 17 on a handle 3 or 4 presently indicates the spatial arrangement on the handle 3 or 4, but not necessarily an arrangement outside a base body of the respective handle 3 or 4.

The connecting point 23 is disposed in a connecting section 20 of the heating foil 16, which is also shown in FIG. 26. The temperature sensor 17 has a spacing m from the connecting point 23. The spacing m is in particular at least 1 cm, especially particularly at least 2 cm. In particular, the temperature sensor 17 has a spacing n which is at least 0.5 cm from each region of a peripheral edge 96 of the heating foil 16. By positioning the temperature sensor 17 at a spacing from the peripheral edge 96 and from the connecting point 23, the temperature actually prevailing on the handle 3 can be detected with a comparatively high level of precision.

A connecting plug 85 on the connecting lines 18 is also shown in FIG. 32. The heater 13 can be connected to the control unit 14 by way of the connecting plug 85. For this purpose, a corresponding plug socket is provided in particular on a circuit board of the control unit 14.

It is understood that the foregoing description is that of the preferred embodiments of the invention and that various changes and modifications may be made thereto without departing from the spirit and scope of the invention as defined in the appended claims.

1. A work apparatus comprising:
a tool;
a drive motor for driving said tool;
a handle for guiding the work apparatus during operation;
an electric heater for said handle;
an electric energy store configured to supply said drive motor and said electric heater with electric power;
a control unit configured to control the electric power supplied to said electric heater; and,
wherein the work apparatus is configured to provide a maximum electric power made available to said electric heater as a function of a charging state of said electric energy store, whereby said control unit only switches said electric heater on and off, and whereby said electric heater in a switched-on state is operated directly with a voltage provided by said electric energy store.

2. The work apparatus of claim 1, wherein said electric heater has a temperature sensor; and, said control unit is configured to feedback-control the electric power made available to said electric heater as a function of a measured value of said temperature sensor.

3. The work apparatus of claim 2, wherein said electric heater includes a heating foil; and, said temperature sensor is disposed at or on said heating foil.

4. The work apparatus of claim 2, wherein said temperature sensor is disposed on said handle.

5. The work apparatus of claim 1, wherein the work apparatus has an activator for switching on said electric heater by an operator; and, the work apparatus is configured such that said activator for switching on said electric heater enables said electric heater to be switched on independently of an operation of said tool.

6. The work apparatus of claim 1, wherein the work apparatus is configured such that an operator can set at least two different target temperatures for said electric heater.

7. The work apparatus of claim 1 further comprising a switch for said heater.

8. The work apparatus of claim 7, wherein said switch is disposed on a top side of the work apparatus.

9. The work apparatus of claim 8 further comprising:
a housing including said top side;
said handle being configured as a tubular handle which engages across said top side of said housing so as to be spaced apart therefrom; and,
said switch, when viewed from above onto the work apparatus, has a spacing of less than 5 centimeters from a section of said tubular handle that engages across said top side.

10. The work apparatus of claim 1 further comprising a connecting unit for establishing a data connection to an external device; and, the work apparatus being configured such that at least one target temperature is able to be set by way of the external device.

11. The work apparatus of claim 1, wherein the work apparatus is configured to set the electric power made available to said electric heater as a function of the electric power consumed by said tool.

12. The work apparatus of claim 1 further comprising:
a second control unit for actuating said drive motor; and,
said control unit for said electric heater being separate from said second control unit.

13. The work apparatus of claim 1 further comprising:
a further handle; and,
a further heater for said further handle.

14. The work apparatus of claim 13, wherein said control unit is configured to control the electric power supplied to said electric heater and said further heater independently of one another.

15. A work apparatus comprising:
a handle assembly;
a tool;
a drive motor for driving said tool;
said handle assembly including a handle and a heater for said handle;
said handle having at least one operator controlled element for actuating said drive motor of the work apparatus;
said heater having a heating element disposed in an interior space of said handle and a carrier disposed in said interior space of said handle;
said heating element being held on said carrier;
said carrier positioning said heating element on an inner surface of said handle; and,
an elastic layer disposed between said carrier and said heating element.

16. The work apparatus of claim 15, wherein said elastic layer has a thickness (h) which is greater than a thickness (k) of said heating element.

17. The work apparatus of claim 15, wherein said carrier presses said heating element against said inner surface of said handle.

18. The work apparatus of claim 15, wherein said carrier is at least partially made of metal.

19. The work apparatus of claim 15 further comprising a temperature sensor disposed on said heating element, wherein said temperature sensor is disposed on a side of said heating element that faces said elastic layer.

20. The work apparatus of claim 15, wherein said carrier covers said elastic layer over at least 80% of an area of said elastic layer.
